(19) United States
(12) Patent Application Publication
(10) Pub. No.: US 2005/0175404 A1
(43) Pub. Date: Aug. 11, 2005

(54) Dual pitch locking connector

(76) Inventor: Christopher J. Conway, Wilmot, NH (US)

Correspondence Address: HARNESS, DICKEY, & PIERCE, P.L.C, 7700 BONHOMME, STE 400, ST. LOUIS, MO, 63105, US

(21) Appl. No.: 11/028,490

(22) Filed: Jan. 3, 2005

Related U.S. Application Data
(63) Continuation of application No. 10/035,534, filed on Nov. 9, 2001, now abandoned.

(51) Int. Cl. F16D 1/00

(52) U.S. Cl. 403/348

(57) ABSTRACT

A connector is provided that comprises a locking ring engaged with a housing, wherein the housing defines a first threaded portion and a second threaded portion, and the locking ring comprises a thread engagement member. The first threaded portion comprises a first pitch that is coarser than a second pitch of the second threaded portion, and accordingly, the thread engagement member engages the first threaded portion and the second threaded portion to secure the locking ring to the housing with a varying amount of axial travel per rotation of the locking ring that corresponds with the pitch of the first threaded portion and the second threaded portion. As a result, the locking ring initially engages the housing with a relatively small rotation followed by relatively larger rotations for complete engagement to a fully mated condition.

### CROSS-REFERENCE TO RELATED APPLICATIONS

The present application is a continuation of U.S. application Ser. No. 10/035,534, titled “Dual Pitch Locking Connector,” filed Nov. 9, 2001, the disclosure of which is incorporated herein by reference in its entirety.

### FIELD OF THE INVENTION

The present invention relates generally to mechanical connectors and more particularly to threaded mechanical connectors for use in fluid and/or electric systems wherein two components are connected through the use of a locking ring.

### BACKGROUND OF THE INVENTION

Threaded mechanical connectors are well known in the art and are often used at a junction to connect components of various systems such as gas lines within a pneumatic system, wires within an electrical system, fluid lines within a fluid system, or fibers within an optical system, among others. In such systems, the threaded mechanical connector often comprises a locking ring that secures a first component to a second component. Generally, the locking ring has internal threads and is rotatably mounted to the first component. Further, the first component is adapted to mate with a second component, i.e., a plug housing adapted to mate with a socket housing, and once the first component is mated with the second component, the locking ring is rotated such that the internal threads of the locking ring engage external threads on the second component. Accordingly, the first and second components are mated together, and the locking ring is rotated such that a connection is achieved as the internal threads of the locking ring successively engage the external threads of the second component.

An example of a threaded mechanical connector that employs a locking ring of the type described herein is disclosed in U.S. Pat. No. 3,328,743 to Acord, wherein an electrical quick disconnect includes a ring nut (i.e., locking ring) having internal threads that engage external threads of an adjacent, or second, component. Similarly, U.S. Pat. No. 3,901,574 to Paullus et al. discloses an electrical connector wherein lugs internal to a locking ring engage grooves external to a second component. Accordingly, the threads internal to a locking ring engage threads external to the second component as the locking ring is rotated to provide a connection between two components.

With many threaded connectors having a locking ring, however, it is often difficult to properly engage the threads to initiate threaded contact. The threads must generally be aligned, and the threads internal to the locking ring must be axially aligned with the threads external to the second component, which often requires a significant amount of rotation of the locking ring to initiate threaded contact. Engagement is particularly difficult and time consuming when the threads of the locking ring and the second component define a relatively fine pitch. To simplify the threaded connection, known art connectors have employed coarser threads in order to facilitate ease of thread engagement. However, a finer pitch generally results in a more robust and reliable connection and thus the coarser threads reduce the robustness and reliability of the connection. Accordingly, a trade-off exists between ease of connection and a robust and reliable connection in threaded connectors of the known art.

To further facilitate ease of connection, some known art connectors employ a locking ring without a conventional threaded interface as described herein. Such connectors generally comprise a feature internal to the locking ring that engages a mating feature external to the component being connected, such as a boss in the locking ring engaging a slot in the component. One such connector is disclosed in U.S. Pat. No. 5,662,488 to Alden, wherein a cylindrical collar (i.e., locking ring) defines internal bosses that traverse along an engagement recess as the cylindrical collar is rotated. The cylindrical collar is rotated until the internal bosses contact an end wall at the end of the engagement recess, thus indicating a fully mated condition.

Yet another mechanical connector having a locking ring without a conventional threaded interface is disclosed in U.S. Pat. No. 3,675,804 to Micalief, wherein individual thread elements internal to a cap (i.e., locking ring) engage a camming surface external to a neck of a container. As the cap is rotated, the thread elements traverse through a single thread, engage the camming surface, and engage corresponding thread elements external to the neck of a container, thereby securing the cap to the container.

Unfortunately, the connection provided by mechanical connectors without a threaded interface is generally less reliable and susceptible to disengagement through various influences in operation such as vibration or sudden impact. Although the connections are made with more ease than those of threaded mechanical connectors, the connection is often less robust and reliable than threaded connections. Additionally, the mechanical connectors of the known art with the deficiencies as described herein are generally directed at a single type of connection, e.g., electric or pneumatic, rather than accommodating multiple connection types.

Accordingly, there remains a need in the art for a connector that is relatively simple to engage and operate, yet which provides a robust and reliable connection. Furthermore, a need exists for such a connector that is also capable of providing a connection between multiple systems, for example, both fluid, (e.g. gas, liquid), and electric, rather that one operational system alone.

### SUMMARY OF THE INVENTION

In one preferred form, the present invention provides a connector that generally comprises a housing defining a first threaded portion and a second threaded portion, wherein the first threaded portion comprises a pitch that is coarser than a pitch of the second threaded portion. A locking ring is also provided that defines a thread engagement member that engages the first threaded portion and the second threaded portion to secure the locking ring to the housing with a varying axial travel per rotation of the locking ring that corresponds with the pitch of the first threaded portion and the second threaded portion. Accordingly, the connector is relatively simple to engage as the thread engagement member engages the coarser threads of the first threaded portion. Furthermore, a robust and reliable connection is provided as the thread engagement member engages the finer threads of the second threaded portion as the locking ring is further rotated.

Preferably, the thread engagement member comprises two diametrically opposed radial protrusions that engage the first threaded portion and the second threaded portion as the locking ring is rotated. Further, the housing preferably comprises at least one thread protrusion disposed within the second threaded portion such that at least one radial protrusion on the locking ring engages the thread protrusion on the housing to provide an audible and tactile indication of a fully mated condition between the locking ring and the housing. Additionally, a lateral stop is preferably disposed at an end of the second threaded portion to limit travel of the locking ring as required.

In another preferred form, a connector is provided that comprises multiple threaded portions extending along a length of a housing, wherein each successive threaded portion along the length comprises a pitch that is different, i.e. finer or coarser, than a pitch of a previous threaded portion. Further, a thread engagement member of a locking ring engages the multiple threaded portions to secure the locking ring to the housing with a varying amount of axial travel per rotation of the locking ring that corresponds with the pitches of the multiple threaded portions. Accordingly, more than two threaded portions are employed to provide a connector that is relatively simple to engage and that provides an increased level of robustness and reliability.

In yet another preferred form, a connector is provided that comprises a second component defining multiple threaded portions extending along a length of the second component, wherein each successive threaded portion along the length comprises a pitch that is different than a pitch of a previous threaded portion. The connector further comprises a first component defining a thread engagement member, wherein the thread engagement member engages the multiple threaded portions to secure the first component to the second component with a varying amount of axial travel per rotation of the first component that corresponds with the pitches of the multiple threaded portions. Accordingly, a locking ring as previously described is not employed to connect the first component to the second component.

With each of the preferred forms of the present invention, the threaded portions may be external to the housing or second component, or may alternately be internal to the housing or second component. Accordingly, the thread engagement member may be internal to the locking ring or first component with the external threaded portions of the housing or second component, and alternately, may be external to the locking ring or first component with the internal threaded portions of the housing or second component.

A method according to the present invention is also provided, wherein two components are connected by engaging a first component comprising a thread engagement member with a second component comprising multiple threaded portions extending along a length of the second component, wherein each successive threaded portion along the length comprises a pitch that is different than a pitch of a previous threaded portion. The first component is then rotated such that the thread engagement member engages the multiple threaded portions to secure the first component to the second component with a varying amount of axial travel per rotation of the first component that corresponds with the different pitches of the multiple threaded portions.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an embodiment of a connector constructed according to the principles of the present invention;

FIG. 2 is an exploded perspective view of an embodiment of a connector constructed according to the principles of the present invention;

FIG. 3a is a side view of an embodiment of a housing constructed according to the principles of the present invention;

FIG. 3b is a rotated side view of the housing of FIG. 3a according to the principles of the present invention;

FIG. 4 is a front view of an embodiment of a locking ring constructed according to the principles of the present invention;

FIG. 5a is a partial side cross sectional view of an engagement member engaging a first threaded portion of a housing according to the principles of the present invention;

FIG. 5b is a partial side cross sectional view, taken along the plane of A-A of FIG. 1, of a thread engagement member engaging a second threaded portion of a housing according to the principles of the present invention;

FIG. 6 is an enlarged perspective view of an embodiment of a housing constructed according to the principles of the present invention;

FIG. 7 is a partial cross-sectional view, taken along the plane of B-B of FIG. 6, of an embodiment of a thread protrusion constructed according to the principles of the present invention;

FIG. 8a is a partial cross-sectional view, taken along the plane of C-C of FIG. 1, of an embodiment of a radial protrusion engaging a thread protrusion according to the principles of the present invention;

FIG. 8b is a partial cross-sectional view, taken along the plane of C-C in FIG. 1, of an embodiment of a radial protrusion traveling over a thread protrusion according to the principles of the present invention;

FIG. 8c is a partial cross-sectional view, taken along the plane of C-C in FIG. 1, of an embodiment of a radial protrusion engaged over a thread protrusion and engaging a lateral stop according to the principles of the present invention;

FIG. 9 is a side cross-sectional view of an embodiment of a housing defining multiple threaded portions and constructed according to the principles of the present invention;

FIG. 10a is a side cross-sectional view of an embodiment of a connector comprising a first component engaging a second component defining multiple threaded portions and constructed according to the principles of the present invention; and

FIG. 10b is a side cross-sectional view of an embodiment of a connector comprising a first component with an external thread engagement member engaging a second component with internal multiple threaded portions according to the principles of the present invention.

### DETAILED DESCRIPTION OF THE PREFERRED EMBODIMENTS

The following description of the preferred embodiments is merely exemplary in nature and is in no way intended to limit the invention, its application, or uses.

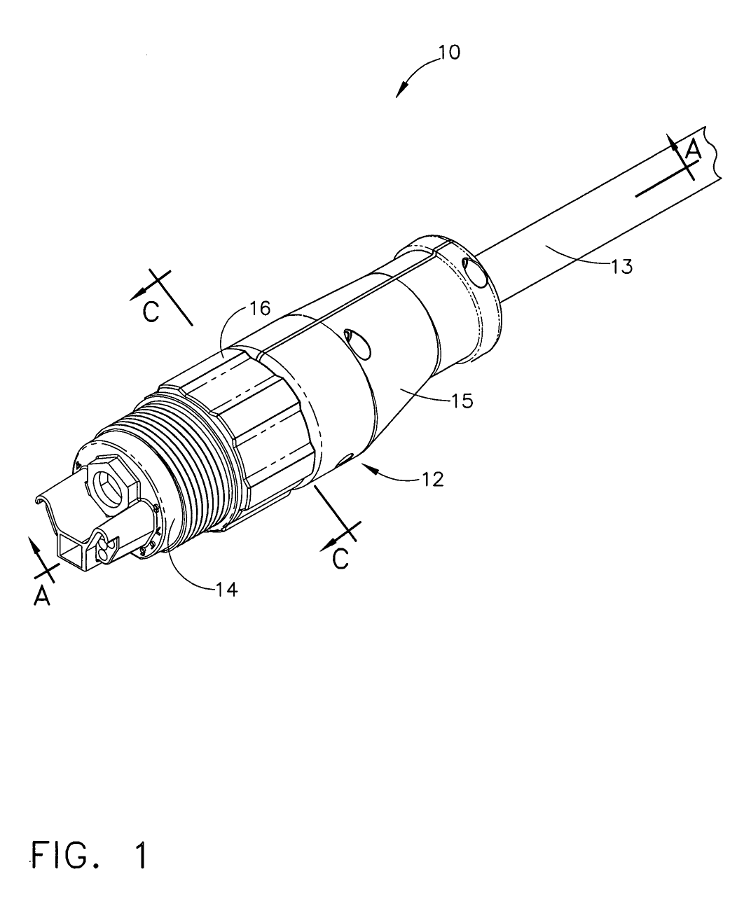

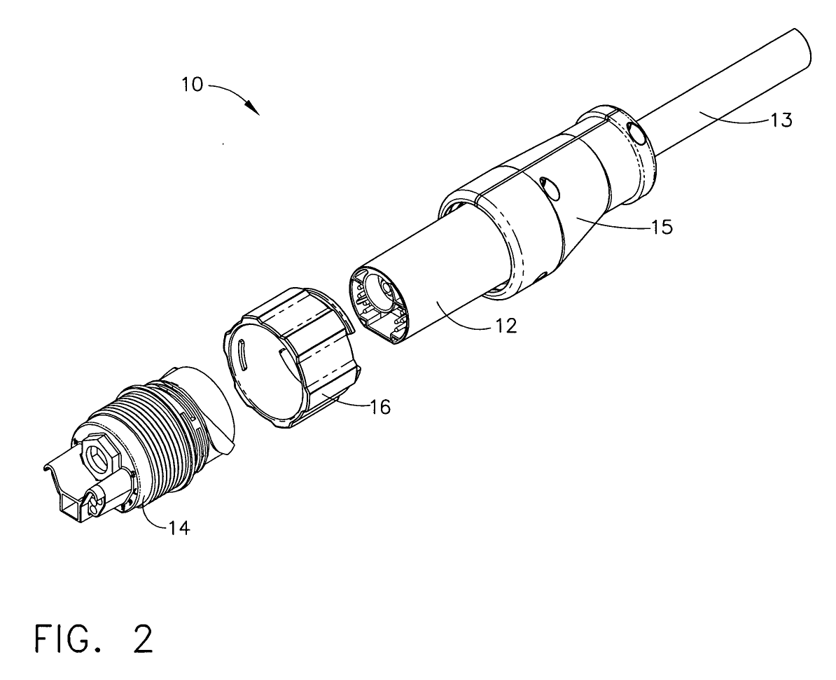

Referring to the drawings, a connector according to one form of the present invention is illustrated and generally indicated by reference numeral 10 in FIGS. 1 and 2. As shown, the connector 10 comprises a plug housing 12 (hidden from view in FIG. 1) disposed within a socket housing 14, and a locking ring 16 rotatably mounted to the plug housing 12. Accordingly, the locking ring 16 secures the plug housing 12 to the socket housing 14 through an innovative threaded connection between the socket housing 14 and the locking ring 16 as described in greater detail below. Further, the socket housing 14 is hereinafter referred to as a housing 14, since the threaded connection according to the present invention may be employed with a male, female, or hermaphrodite component of a connector.

Preferably, the connector 10 is employed in a system that supplies both fluid (e.g., gas, liquid) and electric power (e.g., current), such as a quick disconnect between a power supply (not shown) and a torch lead 13 in a plasma arc apparatus. As used herein, a plasma arc apparatus shall be construed by those skilled in the art to be an apparatus, whether manual or automated, that generates or uses plasma for cutting, welding, spraying, or marking operations, among others. Accordingly, the specific reference to plasma arc cutting torches or plasma arc torches herein shall not be construed as limiting the scope of the present invention.

As further shown, the connector 10 also comprises a plug shell 15, which may be split as shown, for ease of assembly and disassembly of the connector 10. Additionally, the plug shell 15 provides access to fluid and electric conductors disposed within the connector 10 as described in greater detail below. Furthermore, it shall be understood by those skilled in the art that the connector 10 according to the present invention may be employed in a variety of systems such as gas, pneumatic, fluid, optical, or electric, among others, and the reference to fluid and electric for a plasma arc apparatus herein shall not be construed as limiting the scope of the present invention.

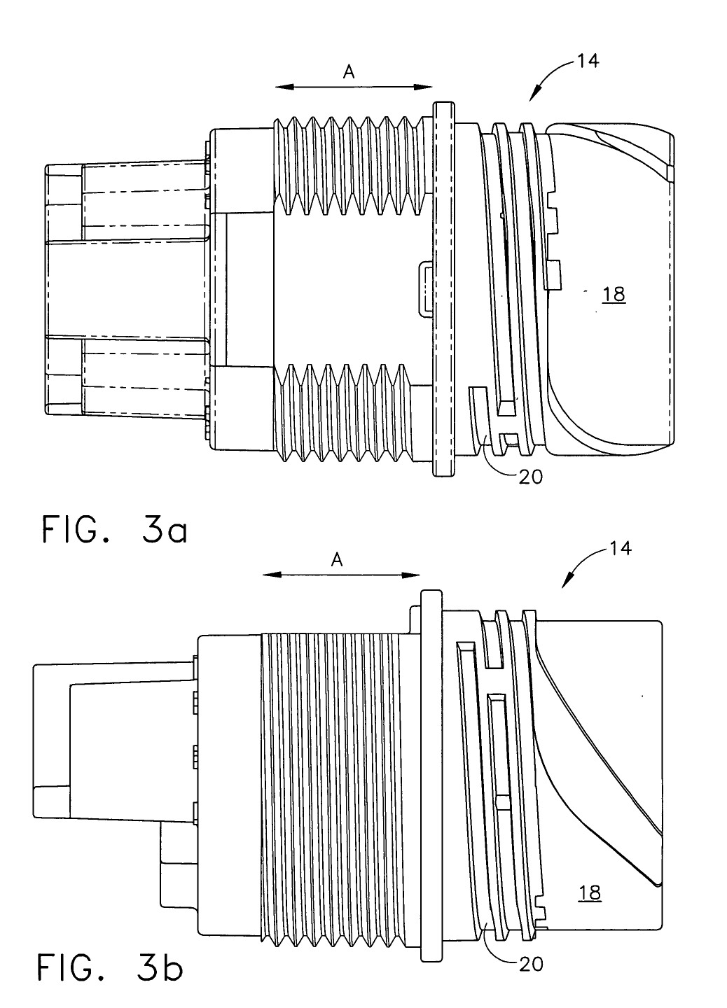

Referring now to FIGS. 3a and 3b, wherein the housing 14 is shown in one position (FIG. 3a) and rotated by 90° in a second position (FIG. 3b), the housing 14 further defines a first threaded portion 18 (i.e., first thread) and a second threaded portion 20 (i.e., second thread) along a length A of the housing 14 as shown. As illustrated, the first threaded portion 18 comprises a first pitch that is coarser than a second pitch of the second threaded portion 20, and the coarser pitch of the first threaded portion 18 preferably continually transitions into the pitch of the second threaded portion 20 as shown to accommodate features of the locking ring 16 as described in further detail below.

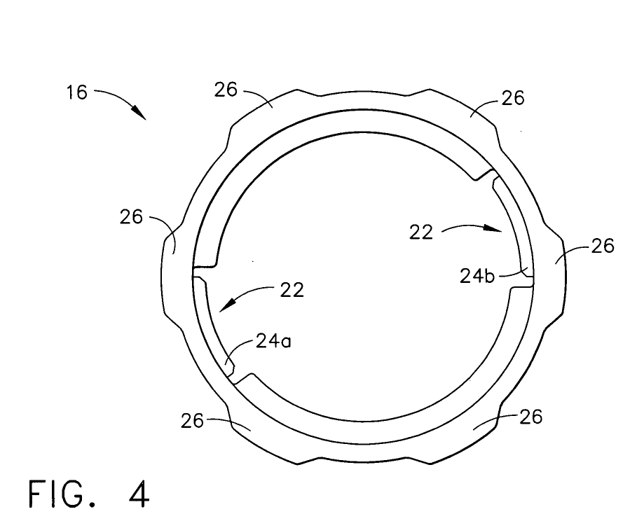

Accordingly, FIG. 4 illustrates a feature of the locking ring 16 that engages the first threaded portion 18 and the second threaded portion 20 of the housing 14, which generally comprises a thread engagement member 22 as shown. Preferably, the thread engagement member 22 comprises two radial protrusions 24a and 24b that engage the first threaded portion 18 and the second threaded portion 20 as the locking ring 16 is rotated around the housing 14. As shown, the radial protrusions 24a and 24b are diametrically opposed in one preferred form of the present invention. Further, the radial protrusions 24a and 24b define an arcuate shape along the interior of the locking ring 16. Accordingly, the radial protrusions 24a and 24b engage the first threaded portion 18 and the second threaded portion 20 when the locking ring 16 is rotated in operation as described in further detail below.

As further shown, the locking ring 16 preferably comprises an exterior surface defining a plurality of axial ridges 26, preferably six (6) as shown, for gripping the locking ring 16 during operation. Accordingly, a user is able to more easily grip and turn the locking ring 16 during operation as the thread engagement member 22 is engaged with the first threaded portion 18 and the second threaded portion 20 of the housing 14.

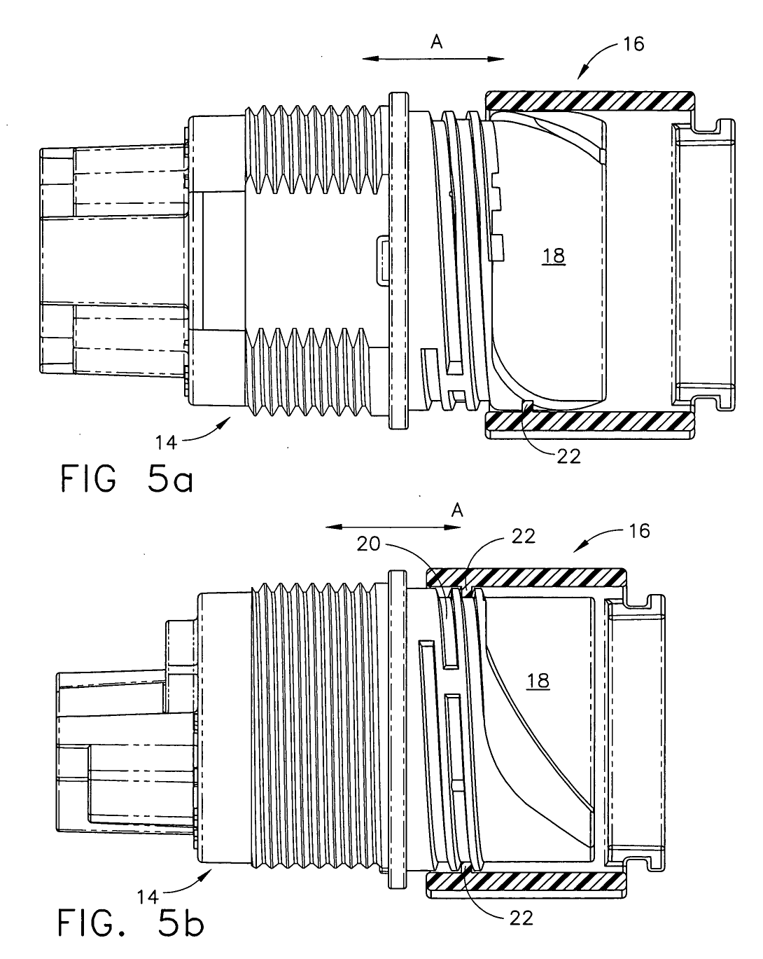

Referring now to FIGS. 5a and 5b, the locking ring 16 is shown engaged with the housing 14 and is rotated such that the thread engagement member 22 engages the first threaded portion 18 (FIG. 5a) and then successively engages the second threaded portion 20 (FIG. 5b) as the locking ring 16 travels along a length A of the housing 14. Since the first threaded portion 18 comprises a coarser pitch than the second threaded portion 20, the locking ring 16 engages the housing 14 with a relatively small rotation of the locking ring 16. Therefore, relatively small rotations of the locking ring 16 results in a relatively large amount of axial travel along length A of the housing 14. As the thread engagement member 22 transitions into the second threaded portion 20, the locking ring 16 engages the housing 14 with a relatively large rotation of the locking ring 16, wherein relatively large rotations of the locking ring 16 results in a relatively small amount of axial travel along length A of the housing 14. Accordingly, the thread engagement member 22 engages the first threaded portion 18 and the second threaded portion 20 to secure the locking ring 16 to the housing 14 with a varying amount of axial travel per rotation of the locking ring 16 that corresponds with the pitches of the first threaded portion 18 and the second threaded portion 20. As a result, the connector 10 is relatively simple to engage and operate through the first threaded portion 18 and further provides a robust and reliable connection through the second threaded portion 20.

Preferably, the housing 14 and the locking ring 16 are fabricated from a polymeric composition such as a fiber-filled nylon, (e.g., Nylon 66) although other materials commonly known in the art may be employed according to specific design requirements. Furthermore, the first threaded portion 18 comprises a pitch of approximately ½ thread per inch, and the second threaded portion 20 comprises a pitch of approximately four (4) threads per inch in one form of the present invention. Accordingly, approximately ¼ of a turn of the locking ring 16 allows the thread engagement member 22 to traverse through the first threaded portion 18, and approximately ¾ of a turn of the locking ring 16 allows the thread engagement member 22 to traverse through the second threaded portion 20 in one preferred form of the present invention.

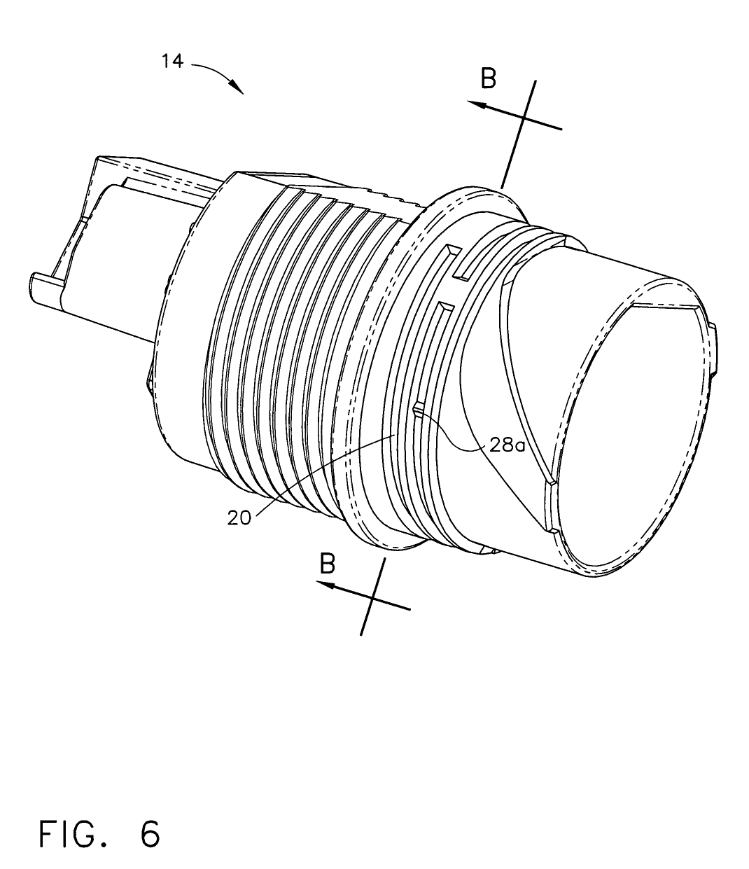

Referring now to FIG. 6, the housing 14 of the present invention further comprises thread protrusions 28a and 28b, (28b hidden from view), disposed within the second threaded portion 20. Accordingly, the radial protrusions 24a and 24b of the locking ring 16 as previously described engage the thread protrusions 28a and 28b as the locking ring 16 is rotated to provide an audible and tactile indication of a fully mated condition as described in greater detail below. Accordingly, the thread protrusions 28a and 28b are preferably diametrically opposed similar to the diametrically opposed radial protrusions 24a and 24b.

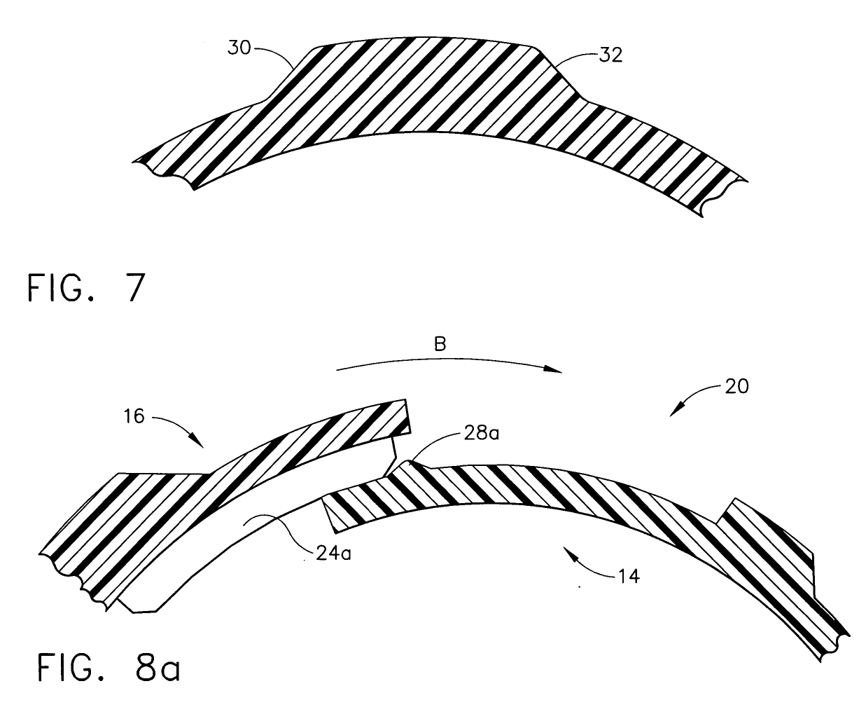

Referring to FIG. 7, the thread protrusions 28a and 28b preferably define first and second sloped surfaces, 30 and 32 respectively. Accordingly, the first and second sloped surfaces 30 and 32 allow the thread engagement member 22 (not shown) to pass over the thread protrusions 28a and 28b more easily as the locking ring 16 is rotated.

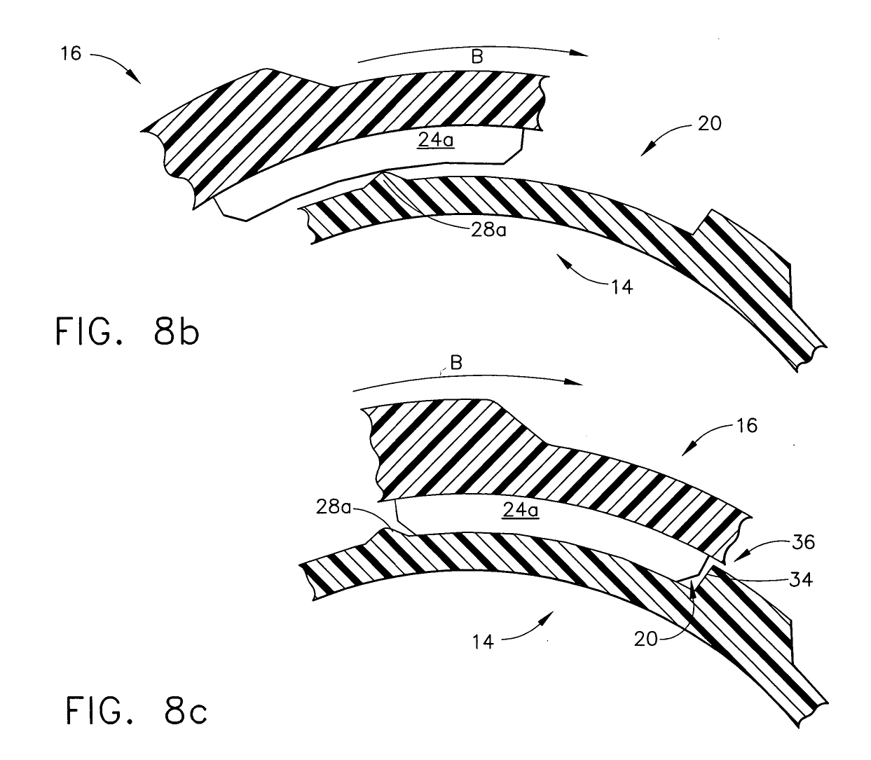

Referring now to FIGS. 8a through 8c, a radial protrusion 24a is shown engaging a thread protrusion 28a as the locking ring 16 is rotated in the direction of arrow B. As the locking ring 16 is rotated, the radial protrusion 24a travels over the thread protrusion 28a and is eventually seated within the second threaded portion 20 past the thread protrusion 28a as shown in FIG. 8c. Accordingly, a slight deformation of the locking ring 16 occurs as the radial protrusion 24a passes over the thread protrusion 28a as shown in FIG. 8b. Further, the housing 14 preferably comprises a lateral stop 34 as shown in FIG. 8c disposed at an end 36 of the second threaded portion 20 in order to further limit travel of the locking ring 16.

As the radial protrusion 24a encounters the thread protrusions 28a, the sloped surfaces 30 and 32 cam the radial protrusion 24a upward as the locking ring 16 continues to be rotated. Further, the radial protrusion 24a passes the thread protrusion 28a and snaps back into the second threaded portion 20, thereby providing an audible and/or tactile confirmation that the connection has been made. Accordingly, at least one of the radial protrusions 24a remains trapped in the second threaded portion 20 between a thread protrusion 28a and the lateral stop 34. Similarly, when disconnecting the connector 10, the radial protrusions 24a are cammed over the thread protrusions 28a by the sloped surfaces 30 and 32. After passing the thread protrusions 28a, the radial protrusions 24a can freely pass through the second threaded portion 20 and the first threaded portion 18 so that the locking ring 16 may be removed from the housing 14.

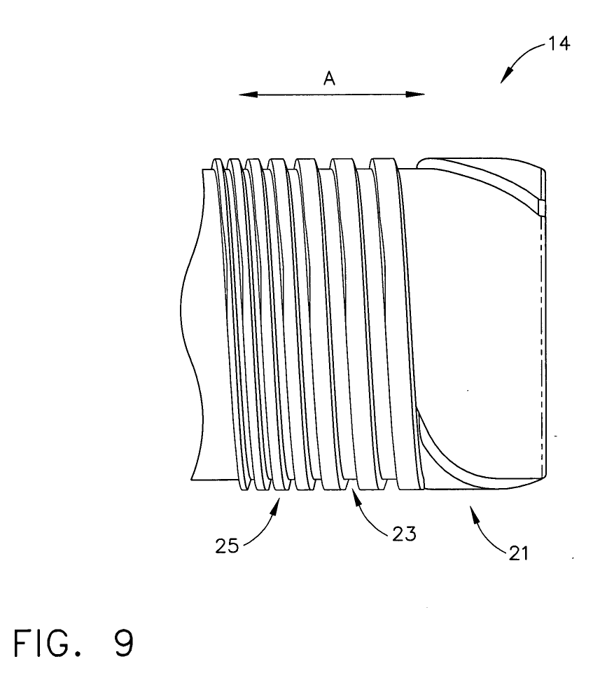

In another form of the present invention, the housing 14 comprises multiple threaded portions as shown in FIG. 9 rather than only a first threaded portion and a second threaded portion as previously described. As shown, the multiple threaded portions 21, 23, and 25 extend along a length A of the housing 14, wherein each successive threaded portion along the length A comprises a pitch that is different, i.e. coarser or finer, than a pitch of a previous threaded portion. Although the threaded portions 21, 23, and 25 as shown comprise successively finer pitches, other combinations of finer and/or coarser pitches may also be employed in accordance with the teachings of the present invention.

Similar to previously described embodiments, the locking ring 16 (not shown) comprises a thread engagement member (not shown) that engages the multiple threaded portions to secure the locking ring 16 to the housing 14 with a varying amount of axial travel per rotation of the locking ring 16 that corresponds with the pitches of the multiple threaded portions. Further, the housing 14 may similarly comprise thread protrusions and a lateral stop as previously described, and the thread engagement member may comprise radial protrusions as previously described such that the locking ring 16 positively engages the housing 14. Moreover, the thread engagement member may be internal to the locking ring 16 as the multiple threaded portions are external to the housing 14, or alternately, the thread engagement member may be external to the locking ring 16 as the multiple threaded portions are internal to the housing 14 (not shown).

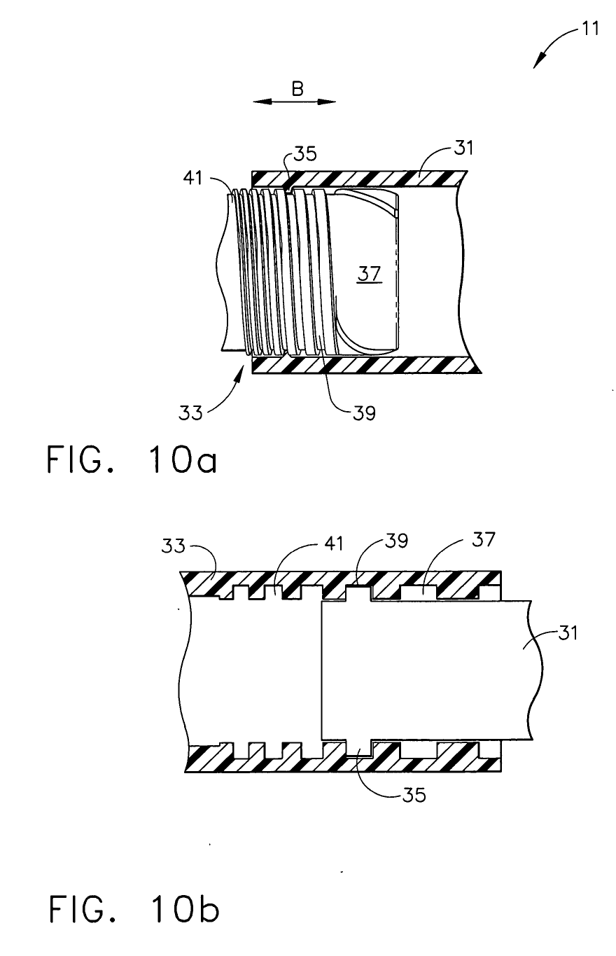

Referring to FIG. 10a, in yet another form of the present invention, a connector 11 is provided that employs threads of a varying pitch as previously described without the use of a locking ring 16. As shown, a first component 31 is connected to a second component 33 as a thread engagement member 35 engages multiple threaded portions 37, 39, and 41 on the second component 33. Accordingly, the second component 33 defines multiple threaded portions 37, 39, and 41 extending along a length B of the second component 33, wherein each successive threaded portion along the length B comprises a pitch that is different, i.e., coarser or finer, than a pitch of a previous threaded portion. Further, a thread engagement member 35 engages the multiple threaded portions 37, 39, and 41 to secure the first component 31 to the second component 33 with a varying amount of axial travel per rotation of the first component 31 that corresponds with the pitches of the multiple threaded portions. Therefore, the connector 11 is relatively simple to engage and operate while providing a robust and reliable connection without the use of a locking ring 16 as previously described.

The second component 33 having multiple threaded portions may also comprise thread protrusions and a lateral stop as previously described. Accordingly, the first component 31 would include a thread engagement member or radial protrusions that engage the thread protrusions and the lateral stop to provide an audible and tactile indication of a fully mated condition of the connector 11.

As further shown in FIG. 10b, the multiple threaded portions 37, 39, and 41 may be internal to the second component 33 rather than external as previously described. Accordingly, the thread engagement member 35 is external to the first component 31 as shown, rather than internal as previously described. As a result, the thread engagement member 35 external to the first component 31 engages the multiple threaded portions 37, 39, and 41 internal to the second component 33 to secure the first component 31 to the second component 33 with a varying amount of axial travel per rotation of the first component 31 that corresponds with the pitches of the multiple threaded portions. Further, although the threaded portions 37, 39, and 41 as shown comprise successively finer pitches, other combinations of finer and/or coarser pitches may also be employed in accordance with the teachings of the present invention

In another preferred form of the present invention, a method of connecting two components is provided that generally comprises the steps of engaging a first component comprising a thread engagement member with a second component comprising multiple threaded portions extending along a length of the second component, wherein each successive threaded portion along the length comprises a pitch that is different, i.e., coarser or finer, than a pitch of a previous threaded portion. The method further comprises the step of rotating the first component such that the thread engagement member engages the multiple threaded portions, wherein the thread engagement member engages the multiple threaded portions to secure the first component to the second component with a varying amount of axial travel per rotation of the first component that corresponds with the pitches of the multiple threaded portions.

Additionally, the method may comprise the step of rotating the first component until the thread engagement member engages a thread protrusion within a threaded portion, wherein an audible and tactile indication of a fully mated condition occurs. Furthermore, the method may also comprise the step of further rotating the first component until the thread engagement member engages a lateral stop at an end of a threaded portion, wherein travel of the first component is limited by the lateral stop.

The description of the invention is merely exemplary in nature and, thus, variations that do not depart from the substance of the invention are intended to be within the scope of the invention. For example, more or less than two (2) radial protrusions that engage the threaded portions of the housing may be employed in accordance with the teachings of the present invention. Further, the housing, locking ring, and/or components may define a cross-sectional geometry other than the circular shape as described herein. Such variations are not to be regarded as a departure from the spirit and scope of the invention.

1. A connector comprising:
a housing defining a first thread extending around and along a portion of the housing and a second thread extending around and along a portion of the housing, wherein the first thread comprises a first pitch that is coarser than a second pitch of the second thread; and
a locking ring defining a thread engagement member,
wherein the thread engagement member first engages the first thread and then successively engages the second thread to secure the locking ring to the housing with a varying amount of axial travel per rotation of the locking ring that corresponds with the first pitch of the first thread and the second pitch of the second thread.

2. The connector of claim 1, wherein the thread engagement member comprises two radial protrusions that successively engage the first thread and the second thread.

3. The connector of claim 2, wherein the two radial protrusions are diametrically opposed.

4. The connector of claim 2 further comprising at least one thread protrusion disposed within the second thread such that at least one of the radial protrusions engages the thread protrusion to provide an audible and tactile indication of a fully mated condition.

5. The connector of claim 4 further comprising a lateral stop disposed at an end of the second thread to limit travel of the locking ring.

6. The connector of claim 2 further comprising two thread protrusions disposed within the second thread such that the two radial protrusions engage the two thread protrusions to provide a tactile indication of a fully mated condition.

7. The connector of claim 6 further comprising a lateral stop disposed at an end of the second thread to limit travel of the locking ring.

8. The connector of claim 1 further comprising at least one thread protrusion disposed within the second thread such that the thread engagement member engages the thread protrusion to provide an audible and tactile indication of a fully mated condition.

9. The connector of claim 1 further comprising a lateral stop disposed at an end of the second thread to limit travel of the locking ring.

10. The connector of claim 1, wherein the locking ring further comprises an exterior surface defining a plurality of axial ridges for gripping the locking ring during operation.

11. A housing for use in a connector, the housing comprising:
a first thread extending around and along a portion of the housing, the first thread defining a first pitch; and
a second thread extending around and along a portion of the housing, the second thread defining a second pitch,
wherein a component first engages the first thread and then successively engages the second thread to secure the component to the housing with a varying amount of axial travel per rotation of the component that corresponds with the first pitch and the second pitch.

12. The housing of claim 11 further comprising at least one thread protrusion disposed within the second thread such that the component engages the thread protrusion to provide a tactile indication of a fully mated condition.

13. The housing of claim 11 further comprising a lateral stop disposed at an end of the second thread to limit travel of the component.

14. A connector comprising:
a housing defining multiple threads extending around a portion of and along a length of the housing, wherein each successive thread along the length comprises a pitch that is different than a pitch of a previous thread,
wherein a component successively engages the multiple threads to secure the locking ring to the housing with a varying amount of axial travel per rotation of the locking ring that corresponds with the pitches of the multiple threads.

15. The connector of claim 14 further comprising at least one thread protrusion disposed within a thread such that the component engages the thread protrusion to provide a tactile indication of a fully mated condition.

16. The connector of claim 14 further comprising a lateral stop disposed at an end of a thread to limit travel of the component.
